(19) United States
(12) Patent Application Publication
(10) Pub. No.: US 2024/0030529 A1
(43) Pub. Date: Jan. 25, 2024

(54) CAP ASSEMBLY

(71) Applicant: Our Next Energy, Inc., Novi, MI (US)

(72) Inventors: Qingcheng Zeng, San Jose, CA (US); Steven Kaye, Oakland, CA (US)

(73) Assignee: Our Next Energy, Inc., Novi, MI (US)

(21) Appl. No.: 18/224,764

(22) Filed: Jul. 21, 2023

Related U.S. Application Data
(60) Provisional application No. 63/391,556, filed on Jul. 22, 2022.

(51) Int. Cl. H01M 50/188; H01M 50/15; H01M 50/152; H01M 50/159; H01M 50/193; H01M 50/184; H01M 50/176; H01M 50/178; H01M 50/557; H01M 50/56; H01M 50/562; H01M 50/342

(52) U.S. Cl. CPC H01M 50/188; H01M 50/15; H01M 50/152; H01M 50/159; H01M 50/193; H01M 50/184; H01M 50/176; H01M 50/178; H01M 50/557; H01M 50/56; H01M 50/562; H01M 50/3425

(57) ABSTRACT

A cap assembly that includes a cap plate having an upper surface and a lower surface, the cap plate being formed to seal an opening of a cell case and to have a terminal hole, an electrode terminal inserted into the terminal hole, and an insulator positioned between the cap plate and the electrode terminal and inserted into the terminal hole, with the insulator making contact with the lower surface of the cap plate. The insulator has a first unibody structure and insulates the electrode terminal from the cap plate.

### TECHNICAL FIELD

The present invention relates generally to a cap assembly for battery cells, housings, and the like. More particularly, the present invention relates to a cap assembly for sealing cells via unibody structures adapted to reduce the number of parts of the cap assembly.

### BACKGROUND

In contrast to primary batteries, which cannot be recharged, rechargeable or secondary batteries may be charged and discharged. Small rechargeable batteries may commonly be found in sophisticated electronic devices such as cell phones and camcorders. Electric and hybrid cars may frequently need large auxiliary batteries to power their motors.

The electrode assembly of some rechargeable cells may be made by stacking a positive electrode and a negative electrode with a separator in between and winding the stacked structure into a roll shape. A casing may house the electrode assembly and an electrolyte solution. A cap plate may be used to seal the casing.

### SUMMARY

The illustrative embodiments disclose a cap for a cell. In one aspect, the cap may comprise a cap plate that comprises an upper surface and a lower surface, the cap plate being configured to seal an opening of a cell case and to have a terminal hole. An electrode terminal of the cap may be inserted along with an insulator into the terminal hole. The insulator may be disposed between the cap plate and the electrode terminal, and the insulator may make contact with the lower surface of the cap plate. The insulator may be unibody and may insulate the electrode terminal from the cap plate.

The cap may also comprise an electrode terminal which further comprises a top portion, a first bottom plate, and at least one first cup arm extending from the first bottom plate and away from the lower surface of the cap plate. The first cup arm may be configured to fit inside an undercut of the insulator.

In another aspect, a cell may be disclosed. The cell may comprise the cap which may be inserted into an opening of a housing of the cell. The cell may be used in a battery pack to provide energy to an electrified/electric vehicle or system as described herein.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cross-section of a cap in which illustrative embodiments may be implemented.

FIG. 2 depicts a cross-section of a cap in which illustrative embodiments may be implemented.

FIG. 3 depicts a cross-section of a cap in which illustrative embodiments may be implemented.

FIG. 4 depicts a cross-section of a cap in which illustrative embodiments may be implemented.

FIG. 5 depicts a cross-section of a cap in which illustrative embodiments may be implemented.

FIG. 6 depicts a cross-section of a cap in which illustrative embodiments may be implemented.

FIG. 7 depicts a cross-section of a cap in which illustrative embodiments may be implemented.

FIG. 8 depicts a cross-section of a cap in which illustrative embodiments may be implemented.

FIG. 9 depicts a cross-section of a cap in which illustrative embodiments may be implemented.

FIG. 10 depicts a cross-section of a cap in which illustrative embodiments may be implemented.

FIG. 11 depicts a cross-section of a cap in which illustrative embodiments may be implemented.

FIG. 12 depicts a flowcharts of a method 1200 n which illustrative embodiments may be implemented.

FIG. 13 depicts a block diagram of a battery pack arrangement in which illustrative embodiments may be implemented.

FIG. 14 depicts a drivetrain and energy storage components in which illustrative embodiments may be implemented.

### DETAILED DESCRIPTION

The illustrative embodiments recognize that conventional cells may have cap assemblies with large numbers of distinct components. The process of assembling these components may be complex and thus may require substantial skill. This complexity may potentially lead to error. As cell technology transforms, cell designs that allow quick assembly may be desired. As the number of distinct assembly components in a cell reduces, cell manufacturing timelines may be reduced along with associated manufacturing costs.

The illustrative embodiments recognize that cells may generally have a cylindrical or a rectangular shape. Each cell may include an electrode group comprising a positive electrode, a separator, and a negative electrode stacked or wound together. A cap may be connected to the positive electrode and may be installed on the top of the cell housing. Liquid electrolyte may be injected through an injection hole formed in the cap and the cap may be sealed. The electrode group may be insulated from the cap and the housing by providing corresponding insulating plates. The illustrative embodiments further recognize that typically a cap may include a negative electrode plate which may be connected to an upper opening of the housing and a positive electrode plate which may be installed in the center of the negative electrode plate via an insulator. This may be assembled into a body by using a rivet penetrating the center of the negative electrode plate and the positive electrode plate. The rivet may be connected to a positive electrode tab of the electrode group and insulated from the negative electrode plate via a gasket. In addition, the negative electrode plate may be provided with a breaking portion as an explosion-proof means for increasing the internal pressure of the battery. In these designs, it may be easily noticed that the cap assembly may comprise too many individual parts, making it difficult to assembly. When large quantities of cap assemblies are needed, this may introduce significant bottlenecks in a factory.

The illustrative embodiments described herein may be directed to a cap that comprises a cap plate with an upper surface and a lower surface, the cap plate being configured to seal an opening of a cell housing. The cap may also comprise an electrode terminal inserted into a terminal hole of the cap plate and an insulator interposed between the cap plate and the electrode terminal. The insulator may have a unibody design that significantly reduces individual components of the cap and a through hole through which the electrode terminal passes. The cap may thus be, in most embodiments, a three-piece structure comprising an insulator disposed between a cap plate and a terminal to provide a tights seal for a cell.

The illustrative embodiments described herein may also be directed to a cell comprising said cap. The cell may have positive and negative terminals on a same side of the cell or on opposite ends of the cell. In one aspect, a cell may comprise a cell housing comprising an opening, and a cap inserted into the opening. Further, a battery comprising a plurality of cells may be disclosed herein. The battery may be designed for use in, for example, electrified/electric vehicles, including, but not limited to, battery electric vehicles (BEV's), plug-in hybrid electric vehicles, motor vehicles, railed vehicles, watercraft, aircraft or to power their drive systems propulsion/all-electric drivetrain. Additionally, the battery may be designed for use in other applications, including, but not limited to, home energy systems configured to utilize rechargeable electric batteries as their main source of energy. In one or more other embodiments, manufacturing a cap is shown. The embodiments recognize that well designed caps may be essential to cell life and may not always be as simple as one might think. It is an exceptionally arduous task to properly minimize cap components while maintaining cell functional and structural integrity. Having generally described the cap, examples and systems thereon will now be described in more detail.

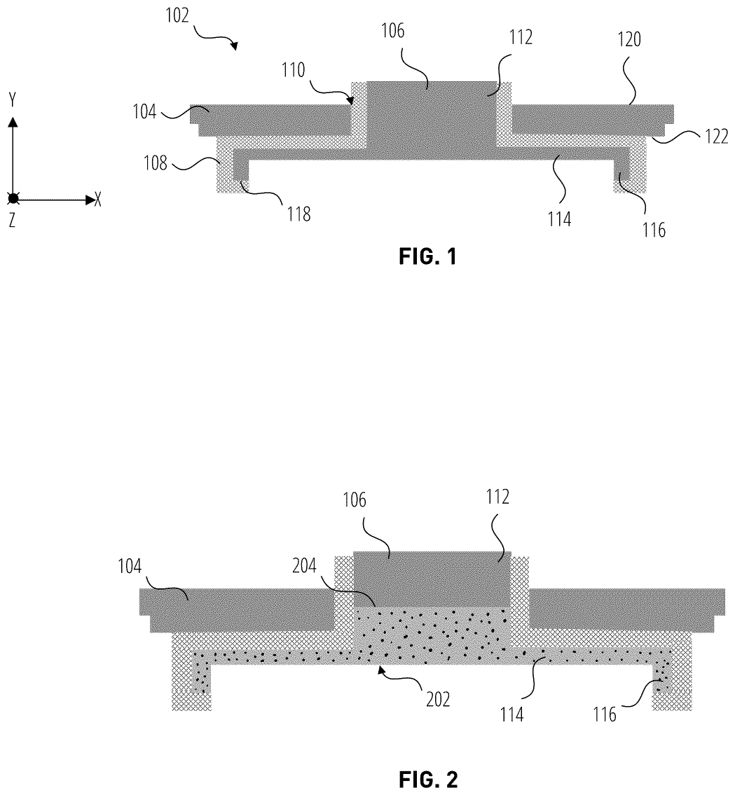

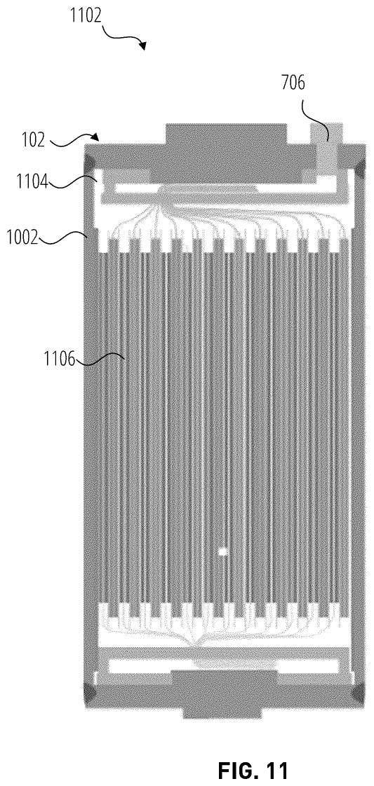

Turning now to FIG. 1, a cap 102 is shown. The cap 102 may comprise a cap plate 104 which may comprise an upper surface 120 and a lower surface 122. The cap plate 104 may be configured to seal an opening of a cell case 1002 (shown in FIG. 10 and FIG. 11). The cap plate may have a terminal hole 110. The cap 102 may also comprise an electrode terminal 106 which may be configured to be inserted into the terminal hole 110. The cap 102 may also comprise an insulator 108 disposed between the cap plate 104 and electrode terminal 106 and also inserted into the terminal hole 110, with the insulator 108 making contact with the lower surface 122 of the cap plate 104 and an upper surface of the electrode terminal 106.

The insulator 108 may be a unibody structure and may be configured to insulate the electrode terminal 106 from the cap plate 104. In the embodiment of FIG. 1, the cap 102 may be a three-piece structure, with the insulator 108 of the cap being over-molded onto the electrode terminal 106. The number of parts of the cap 102 may thus be significantly reduced (for example, from 6-9 or more individual interconnecting components to 3 individual interconnecting components, or for example, from 3-4 or more different pieces of insulators to one piece of insulator). This may significantly simplify the cell manufacturing and assembly process. The cap plate 104 may provide sealing and serve as part of the housing of the cell.

The electrode terminal may comprise a top portion 112, a first bottom plate 114 in a bottom portion disposed below the top portion, and cup arms including a first cup arm 116.

The first cup arm 116 may extend from the first bottom plate 114 and away from the lower surface 122 of the cap plate 104, with the first cup arm 116 being configured to fit inside an undercut 118 of the insulator 108. This may provide a tight seal especially when a material of the insulator is appropriately selected to allow bonding of the cap plate to the terminal upon melting the insulator polymer. Further, the first bottom plate 114 interconnecting with the insulator may provide support to the terminal structure as a whole, making it resistant to movements induced by external forces acting on the cell.

As shown in FIG. 1, the electrode terminal 106 may include the same material as the cap plate. Further the electrode material may be unibody and thus be made of one material type. However, in other cases the electrode terminal 106 may comprise different types of materials and may be made of a material that is different from the material of the cap plate.

As shown in FIG. 2, the electrode terminal 106 may have a bimetal clad design in which the first bottom plate 114 and the first cup arm 116 form a cladding 202 that includes a different material from the material of the top portion 112. This may be used for certain designs such as anode terminal designs. Further, an interface 204 between the terminal material and the bottom plate material may be straight (FIG. 2) or rough (FIG. 6), such as a corrugated interface or interface with triangular ridges 612 which may increase mechanical coupling between the two dissimilar materials). In the embodiment of FIG. 2, the top portion 112 may comprise the same material as the material of the cap plate 104. In one or more embodiments, the cladding 202 may comprise copper or stainless-steel material and the top portion 112 and cap plate 104 may comprise aluminum.

In an aspect herein, the cap plate 104 may be bonded to the electrode terminal 106 by heat lamination. Herein, the insulator 108 may be melted to bond the cap plate 104 and terminal 106 together. Further, the cap plate and terminal may be surface treated, for example, with Cr4+(chromium) or CrO2 (chromium dioxide) to improve bonding.

The insulator material may comprise CPP (cast polypropylene). CPP may be chosen because of its ability to seal and laminate. This may provide the insulation of the terminal to the cap plate and also act as a sealant. In an aspect, the electrode terminal 106 comprises aluminum material. The cap plate may also comprise aluminum similarly or independently from the aluminum electrode terminal. Of course, these are only examples and are not meant to be limiting. Other technical features may be readily apparent to one skilled in the art from the following figures and descriptions.

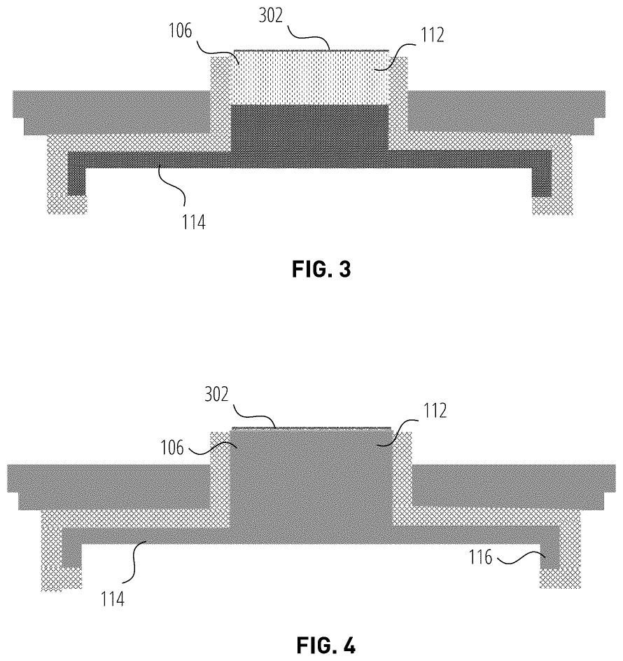

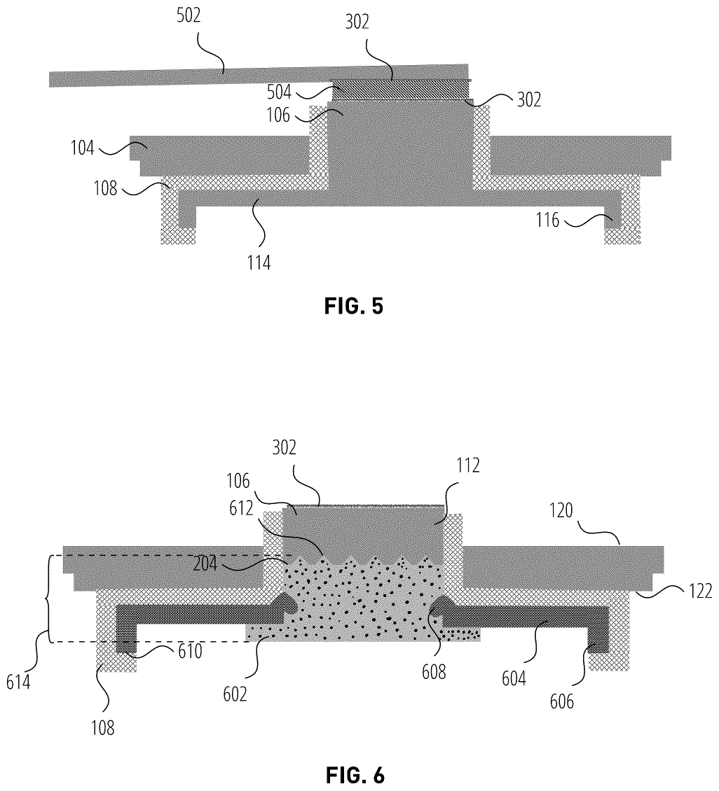

Turning now to FIG. 3, a cap having a plating 302 is shown. The plating 302 may be disposed on a terminal having another bimetal clad design as shown in FIG. 3 or on a unibody terminal as shown in FIG. 4. As shown in FIG. 5, the plating 302 may be configured to bond a low melting point alloy 504 to a busbar 502 and to the electrode terminal 106. Specifically, available melting alloys may not adhere well with busbars and terminals, such as aluminum busbars and aluminum terminals. Therefore, an interface layer (plating 302) that may bond well to aluminum as busbars or terminals and that may also well to the low melting point alloy 504 may be needed. This may improve serviceability or disassembly. Therefore, once a cell fails, localized heating may be used to remove the busbar and remove the cell by easily melting the alloy. In the embodiment of FIG. 3, the first bottom plate 114 may be made from, for example, stainless steel and the top portion 112 may be made from a material different from that of the cap plate, for example. The plating 302 may be comprised of nickel. In some cases, the layer may be a disk and may be comprised of stainless steel welded on top of the aluminum material. For example, in FIG. 3 and in FIG. 6 the plating may comprise stainless steel/nickel plating or just nickel plating. In FIG. 4, the plating may comprise stainless steel plating, or nickel plating.

In another aspect as shown in FIG. 6, the electrode terminal 106 may comprise a top portion 112, a third bottom plate 602 extending from the top portion 112, and a second bottom plate 604 distinct from the third bottom plate 602, and at least partially disposed between the third bottom plate 602 and the insulator 108. The second bottom plate 604 may be bonded to the third bottom plate 602 by a joint such as a laser joint 608 to form a coupled lower portion 614 of the terminal. The second bottom plate 604 may have a second cup arm 606 extending therefrom and away from the lower surface of the cap plate 104. The laser joint 608 may provide a tight mechanical coupling between the third bottom plate 602 and the second bottom plate 604 as they are not one body. The material of the second bottom plate 604 may be different from the third bottom plates 602 because, for example, the third bottom plate may be made of an expensive material such as copper and thus, another material such as stainless steel may be bonded to the copper to provide support while reducing cost.

The second cup arms 606 may be designed to fit inside another undercut 610 of the insulator 108. In an embodiment, the third bottom plate 602 is comprised of copper and the second bottom plate is comprised of stainless steel. Further, an interface 204 between the coupled lower portion 614 and the top portion 112 of the terminal may be corrugated with ridges. This may provide a stronger mechanical connection between the coupled lower portion and the top portion as compared to a mechanical connection provided by a straight interface. Other technical features may be readily apparent to one skilled in the art from the descriptions shown herein.

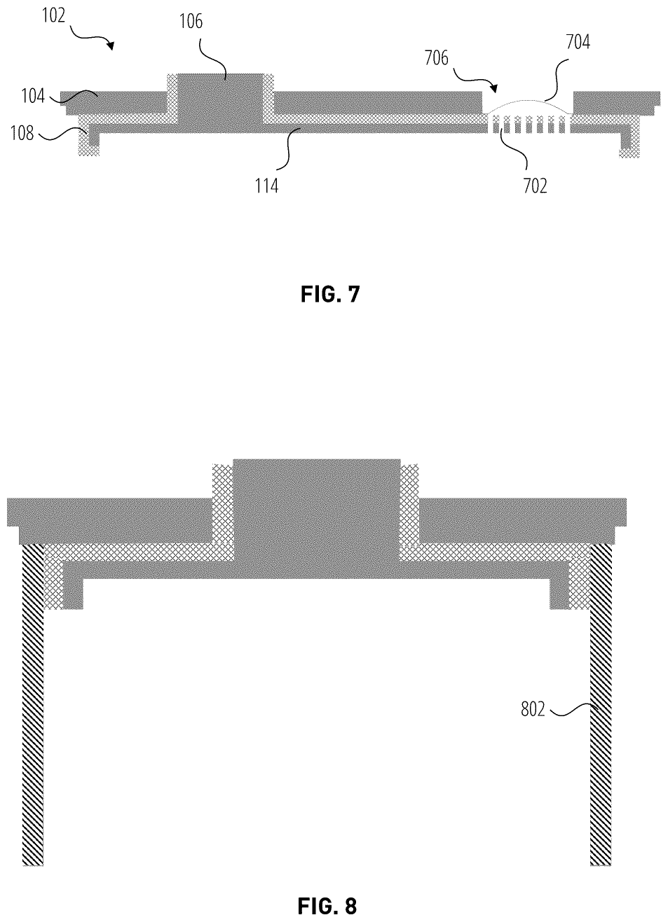

FIG. 7 illustrates a cross-section of another cap 102 in accordance with illustrative embodiments. The cap may comprise a vent 706 formed by one or more vent holes 702 and a vent cover 704. The vent may be activated to reduce the internal pressure of a cell having the caps to release pressure and/or accumulated gases.

As shown in FIG. 8, the cap may include a temporary can wall 802 affixed to the insulator and configured to provide a temporary housing for an electrolyte. In an embodiment, prior to introducing electrolyte and the electrode stack into a cell, the temporary can wall 802 may serve as an open-ended housing to hold the electrolyte and/or electrode stack. When ready to be inserted into the can, the whole cap with the electrolyte and electrode stack may be inserted into the can to produce a finished cell.

In some embodiments, the temporary can wall 802 may comprise a polymer that is bonded to the insulator by application of heat. The polymer may be, for example, cast polypropylene (CPP).

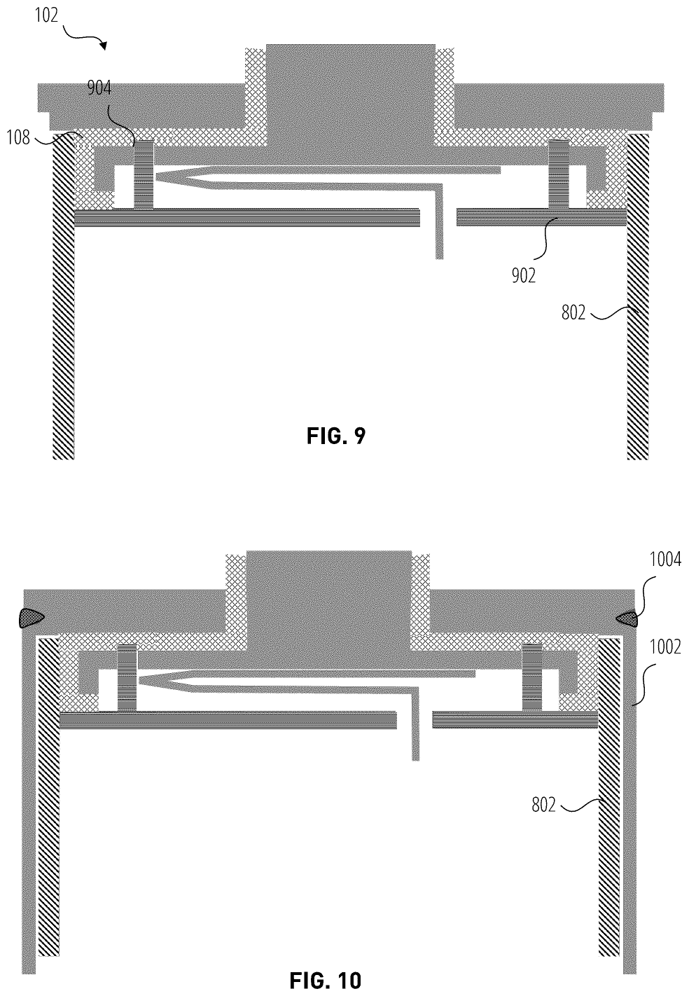

As shown in FIG. 9, the cap 102 may also include another insulator (positioning insulator 902) disposed below the insulator 108 to provide support to the electrode terminal via a heat joint between the positioning insulator 902 and the insulator 108. The positioning insulator 902 may have a clipper/hook function wherein the positioning insulator 902 may be hooked into a positioning hole 904 in the insulator 108 and/or heated to be joined to the insulator 108. Further, the positioning insulator may have a heat joint to the temporary can wall 802 to provide stability for the electrode terminal and other components of the cap.

When the temporary can wall 802 is inserted into a cell case 1002, the cap may be sealed or affixed to the cell case 1002 on the ends of the cap via, for example, a laser welding joint 1004 as shown in FIG. 10.

In another aspect, a cell 1102 may be disclosed. The cell may comprise a cell housing/cell case 1002 including a an opening 1104, and a cap 102 inserted into the opening 1104. The cell housing may house the electrode stack 1106 and an electrolytic solution (not shown).

The cell may also include further include a vent 706 disposed in the cap 102 and configured to be activated to reduce the internal pressure of the cell 1102 and release the accumulated gases. The cell may also be a prismatic cell or a cylindrical cell. The cell may also have positive and negative terminals on the same cap or on different caps. Of these, the examples given herein are not meant to be limiting and other technical features and variations may be readily apparent to one skilled in the art from the following the descriptions and figures provided.

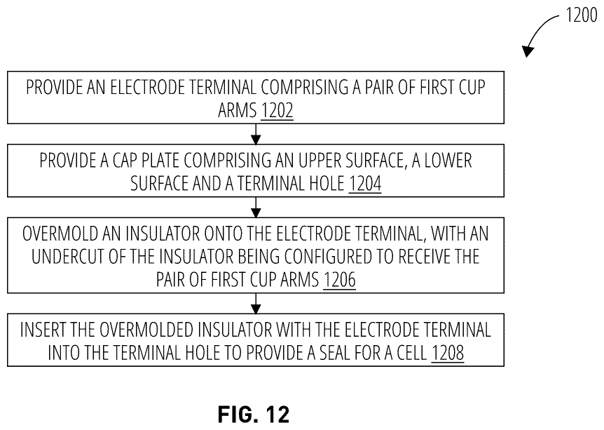

FIG. 12 illustrates a method 1200 of manufacturing a cap and thus a cell. The method may begin at step 1202 wherein method 1200 provides an electrode terminal comprising a pair of first cup arms. In step 1204, method 1200 provides a cap plate comprising an upper surface, a lower surface and a terminal hole. An insulator may also be provided. Surfaces of the electrode terminal and the cap plate that may come into contact with the insulator may be pre-treated with Cr4+ or CrO2 to improve bonding and hence the hermetic seal performance. In step 1206, method 1200 over-molds an insulator onto the electrode terminal, with an undercut of the insulator being configured to receive the pair of first cup arms. In step 1208, method 1200 inserts the over-molded insulator with the electrode terminal into the terminal hole to provide a seal for a cell. The insulator may be designed to have a unibody structure. The insulator may then be melted to bond the cap plate to the terminal. The cap may then be sealed onto a cell 1102 having an electrode stack and electrolyte to form a manufactured cell.

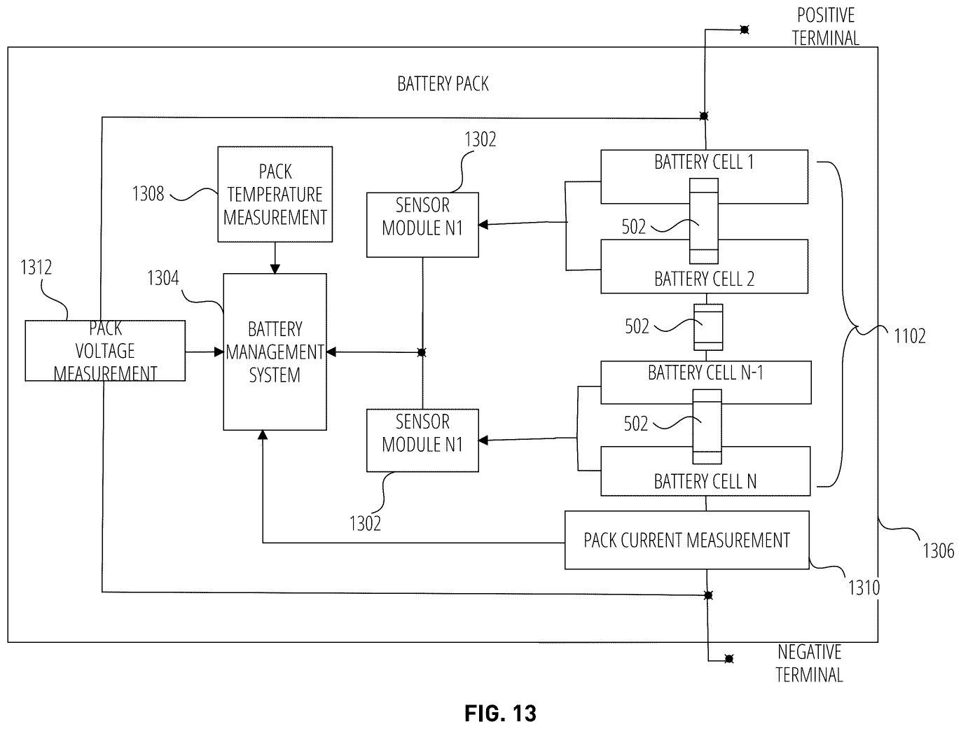

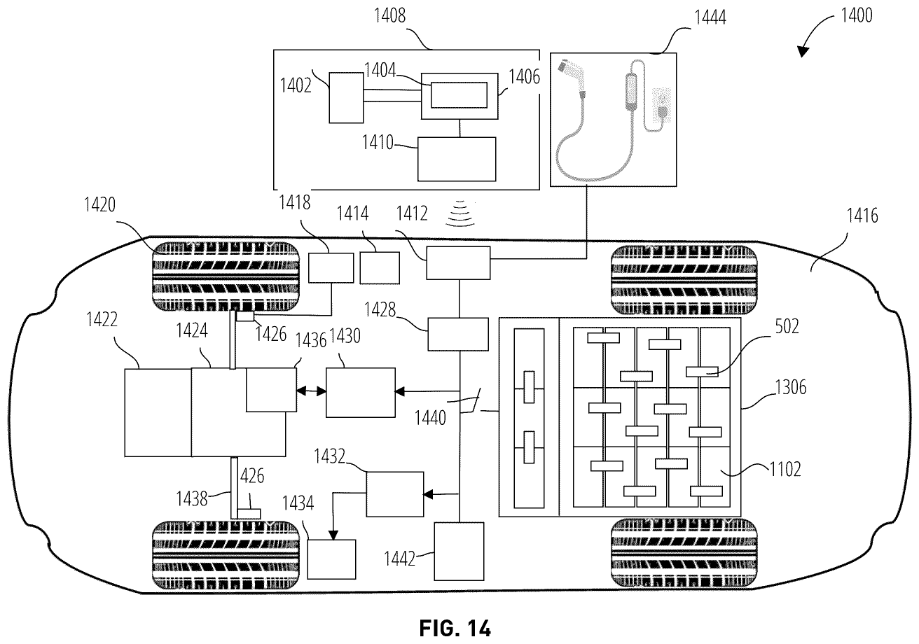

Turning now to FIG. 14, a schematic of a battery pack in which a cell 1102 may be used is described herein. The battery pack assembly 1306 may be constructed from one or a variety of chemical formulations. FIG. 13 shows a schematic of the battery pack assembly 1306 in a simple series configuration of N cells 1102. Other battery pack assemblies 1306, however, may be composed of any number of individual battery cells connected in series or parallel or some combination thereof. The battery pack assembly 1306 may have a one or more plated busbars 502 discussed herein connecting the cells 1102. The battery pack assembly 1306 may also have controllers such as the battery management system (BMS 1304) that may monitor and control the performance of the battery pack assembly 1306. The BMS 1304 may monitor several battery pack level characteristics such as pack current 1310, pack voltage 1312 and pack temperature 1308. The BMS 1304 may have non-volatile memory such that data may be retained when the BMS 1304 is in an off condition. Retained data may be available upon the next key cycle.

In addition to monitoring the pack level characteristics, there may be cell 1102 level characteristics that are measured and monitored. For example, the terminal voltage, current, and temperature of each cell 1102 may be measured. A system may use a sensor module(s) 1302 to measure the cell 1102 characteristics. Depending on the capabilities, the sensor module(s) 1302 may measure the characteristics of one or multiple of the cells 1102. Each sensor module(s) 1302 may transfer the measurements to the BMS 1304 for further processing and coordination. The sensor module(s) 1302 may transfer signals in analog or digital form to the BMS 1304. In some embodiments, the sensor module(s) 1302 functionality may be incorporated internally to the BMS 1304. That is, the sensor module(s) 1302 hardware may be integrated as part of the circuitry in the BMS 1304 and the BMS 1304 may handle the processing of raw signals.

It may be useful to calculate various characteristics of the battery pack. Quantities such as battery power capability and battery state of charge may be useful for controlling the operation of the battery pack as well as any electrical loads receiving power from the battery pack. Battery power capability is a measure of the maximum amount of power the battery can provide or the maximum amount of power that the battery can receive for the next specified time period, for example, one second or less than one second. Knowing the battery power capability allows electrical loads to be managed such that the power requested is within limits that the battery can handle.

Battery pack state of charge (SOC) gives an indication of how much charge remains in the battery pack. The battery pack SOC may be output to inform the driver of how much charge remains in the battery pack, similar to a fuel gauge. The battery pack SOC may also be used to control the operation of an electric vehicle. Calculation of battery pack or cell SOC can be accomplished by a variety of methods. One possible method of calculating battery SOC is to perform an integration of the battery pack current over time. Calculation of battery pack or cell SOC can also be accomplished by using an observer, whereas a battery model is used for construction of the observer, with measurements of battery current, terminal voltage, and temperature. Battery model parameters may be identified through recursive estimation based on such measurements. The BMS 1304 may estimate various battery parameters based on the sensor measurements. The BMS 1304 may further ensure by way of the pack current 1310 that a current of the cells 1102 does not exceed a defined continuous current carrying capacity of the busbars 502. Upon determining that a cell is defective, the cell 1102 may be easily removed by application of heat to melt the low melting point alloy 504.

Turning to FIG. 14, a schematic of a generalized electric vehicle system 1400 in which a battery pack assembly 1306 housing the cells 1102 may be used will be described. It will become apparent to a person skilled in the relevant art(s) that the concepts described herein are directed to all electrified/electric vehicles and systems, including, but not limited to, battery electric vehicles (BEV's), plug-in hybrid electric vehicles, motor vehicles, railed vehicles, watercraft, aircraft, to power their drive systems propulsion or load or that possess an all-electric drivetrain. Additionally, it will become apparent to a person skilled in the relevant art(s) that the concepts described herein are directed towards home systems configured to utilize rechargeable electric batteries as their main source of energy. The electric vehicle 1416 may comprise one or more electric machine 1436 mechanically connected to a transmission 1424. The electric machine 1436 may be capable of operating as a motor or a generator. In addition, the transmission 1424 may be mechanically connected to an engine 1422, as in a PHEV. The transmission 1424 may also be mechanically connected to a drive shaft 1438 that is mechanically connected to the wheels 1418. The electric machine 1436 can provide propulsion and deceleration capability when the engine 1422 is turned on or off. The electric machine 1436 also act as generators and can provide fuel economy benefits by recovering energy that would normally be lost as heat in the friction braking system. The electric machine 1436 may also reduce vehicle emissions by allowing the engine 1422 to operate at more efficient speeds and allowing the electric vehicle 1416 to be operated in electric mode with the engine 1422 off in the case of hybrid electric vehicles.

A battery pack assembly 1306 stores energy that can be used by the electric machine 1436. The battery pack assembly 1306 typically provides a high voltage DC output and is electrically connected to one or more power electronics modules 1430. In some embodiments, the battery pack assembly 1306 comprises a traction battery and a range-extender battery. Cells 1102 of the battery pack assembly 1306 may be electrically coupled by busbars 502 described herein. One or more contactors 1440 may isolate the battery pack assembly 1306 from other components when opened and connect the battery pack assembly 1306 to other components when closed. To increase the assembly and manufacturing speed for electric vehicles, a structure of the cell caps 102 may be designed to eliminate unnecessary parts, save space and reduce assembly bottlenecks. The battery pack assembly may also have a cell-to-pack configuration. For example, a battery pack configuration may include cells directly placed in an enclosure without the use of separate modules, with the enclosure also housing other hardware such as, but not limited to the power electronics module 1430, DC/DC converter module 1432, system controller 1414 (such as a battery management system (BMS)), power conversion module 1428, battery thermal management system (cooling system and electric heaters) and contactors 1440. By optimizing the cell cap structure, a consolidated space saving arrangement may be provided that may increase usable volume and increase cell energy density without sacrificing flexibility and safety.

The power electronics module 1430 may also electrically connected to the electric machine 1436 and may provide the ability to bi-directionally transfer energy between the battery pack assembly 1306 and the electric machine 1436. For example, a traction or range-extender battery may provide a DC voltage while the electric machine 1436 may operate using a three-phase AC current. The power electronics module 1430 may convert the DC voltage to a three-phase AC current for use by the electric machine 1436. In a regenerative mode, the power electronics module 1430 may convert the three-phase AC current from the electric machine 1436 acting as generators to the DC voltage compatible with the battery pack assembly 1306. The description herein is equally applicable to a BEV. For a BEV, the transmission 1424 may be a gear box connected to an electric machine 14 and the engine 1422 may not be present.

In addition to providing energy for propulsion, the battery pack assembly 1306 may provide energy for other vehicle electrical systems. A typical system may include a DC/DC converter module 1432 that converts the high voltage DC output of the battery pack assembly 1306 to a low voltage DC supply that is compatible with other loads. Other electrical loads 1442, such as compressors and electric heaters, may be connected directly to the high-voltage without the use of a DC/DC converter module 1432. The low-voltage systems may be electrically connected to an auxiliary battery 1434 (e.g., 116V battery).

The battery pack assembly 1306 may be recharged by a charging system such as a wireless vehicle charging system 1408 or a plug-in charging system 1444. The wireless vehicle charging system 1408 may include an external power source 1402. The external power source 1402 may be a connection to an electrical outlet. The external power source 1402 may be electrically connected to electric vehicle supply equipment 1406 (EVSE). The electric vehicle supply equipment 1406 may provide an EVSE controller 1404 to provide circuitry and controls to regulate and manage the transfer of energy between the external power source 1402 and the electric vehicle 1416. The external power source 1402 may provide DC or AC electric power to the electric vehicle supply equipment 1406. The electric vehicle supply equipment 1406 may be coupled to a transmit coil 1410 for wirelessly transferring energy to a receiver 1412 of the vehicle 1416 (which in the case of a wireless vehicle charging system 1408 is a receive coil). The receiver 1412 may be electrically connected to a charger or on-board power conversion module 1434. The receiver 1412 may be located on the underside of the electric vehicle 1416. In the case of a plug-in charging system 1444, the receiver 1412 may be a plug-in receiver/charge port and may be configured to charge the battery pack assembly 1306 upon insertion of a plug-in charger. The power conversion module 1428 may condition the power supplied to the receiver 1412 to provide the proper voltage and current levels to the battery pack assembly 1306. The power conversion module 1428 may interface with the electric vehicle supply equipment 1406 to coordinate the delivery of power to the electric vehicle 1416.

One or more wheel brakes 1426 may be provided for decelerating the electric vehicle 1416 and preventing motion of the electric vehicle 1416. The wheel brakes 1426 may be hydraulically actuated, electrically actuated, or some combination thereof. The wheel brakes 1426 may be a part of a brake system 1418. The brake system 1418 may include other components to operate the wheel brakes 1426. For simplicity, the figure depicts a single connection between the brake system 1418 and one of the wheel brakes 1426. A connection between the brake system 1418 and the other wheel brakes 1424 is implied. The brake system 1418 may include a controller to monitor and coordinate the brake system 1418. The brake system 1418 may monitor the brake components and control the wheel brakes 1426 for vehicle deceleration. The brake system 1418 may respond to driver commands and may also operate autonomously to implement features such as stability control. The controller of the brake system 1418 may implement a method of applying a requested brake force when requested by another controller or sub-function.

One or more electrical loads 1442 may be connected to the busbars 502. The electrical loads 1442 may have an associated controller that operates and controls the electrical loads 1442 when appropriate. Examples of electrical loads 1442 may be a heating module or an air-conditioning module.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A cap comprising:
a cap plate comprising an upper surface and a lower surface, the cap plate configured to seal an opening of a cell case and to have a terminal hole;
an electrode terminal inserted into the terminal hole; and
an insulator disposed between the cap plate and electrode terminal and inserted into the terminal hole, the insulator making contact with the lower surface of the cap plate;
wherein the insulator has a first unibody structure and is configured to insulate the electrode terminal from the cap plate.

2. The cap of claim 1, wherein the electrode terminal further comprises:
a top portion;
a first bottom plate; and
at least one first cup arm extending from the first bottom plate and away from the lower surface of the cap plate;
wherein the at least one first cup arm is configured to fit inside an undercut of the insulator.

3. The cap of claim 2, wherein the electrode terminal comprises a same material as a material of the cap plate.

4. The cap of claim 2, wherein the electrode terminal has a bimetal clad design, wherein the first bottom plate and said at least one first cup arm form a cladding that comprises a different material from the material of the top portion.

5. The cap of claim 4, wherein the top portion of the electrode material comprises a same material as a material of the cap plate.

6. The cap of claim 4, wherein the cladding comprises copper or stainless steel material.

7. The cap of claim 2, wherein the cap plate is bonded to the electrode terminal by heat lamination.

8. The cap of claim 7, wherein the cap plate and electrode terminal surfaces are treated with CrO2 (chromium dioxide).

9. The cap of claim 1, wherein the insulator is molded over the electrode terminal.

10. The cap of claim 1, wherein the electrode terminal has a second unibody structure.

11. The cap of claim 1, wherein the insulator comprises CPP (cast polypropylene) material.

12. The cap of claim 1, wherein the electrode terminal comprises aluminum material.

13. The cap of claim 1, wherein the cap plate comprises aluminum material.

14. The cap of claim 1, wherein the cap comprises a plating layer disposed on the terminal and configured to bond an alloy having with a plated busbar, wherein the alloy has a lower melting point than a melting point of the terminal.

15. The cap of claim 1, wherein the electrode terminal further comprises:
a top portion;
a third bottom plate extending from the top portion; and
second bottom plate distinct from the third bottom plate, disposed between the third bottom plate and the insulator, and bonded to the third bottom plate by a laser joint to form a coupled lower portion of the terminal;
wherein the second bottom plate has at least one second cup arm extending therefrom and away from the lower surface of the cap plate.

16. The cap of claim 15, wherein the at least one second cup arm is configured to fit inside another undercut of the insulator.

17. The cap of claim 1, wherein the third bottom plate comprises copper material and the second bottom plate comprises stainless steel material.

18. The cap of claim 1, wherein an interface between the coupled lower portion and the top portion of the terminal is corrugated with ridges.

19. The cap of claim 1, further comprising:
a temporary can wall affixed to the insulator and configured to provide a temporary housing for an electrolyte.

20. The cap of claim 1, wherein the temporary can wall comprises a polymer that is bonded to the insulator by application of heat.

21. The cap of claim 20, wherein the polymer comprises cast polypropylene material.

22. The cap of claim 1, further comprising another insulator disposed below said insulator to provide support to the electrode terminal via a heat joint between said another insulator and said insulator, wherein the another insulator is a positioning insulator that has a clipper/hook function.

23. A cell comprising:
a cell housing comprising an opening; and
a cap inserted into the opening;
the cap further comprising:
a cap plate comprising an upper surface and a lower surface, the cap plate configured to seal an opening of a cell case and to have a terminal hole;
an electrode terminal inserted into the terminal hole; and
an insulator disposed between the cap plate and electrode terminal and inserted into the terminal hole, the insulator making contact with the lower surface of the cap plate;
wherein the insulator has a unibody structure and is configured to insulate the electrode terminal from the cap plate.

24. The cell of claim 23, further comprising:
a vent disposed in the cap and configured to be activated to reduce an internal pressure of the cell and release the accumulated gases.

25. The cell of claim 23, wherein the cell is a prismatic cell or a cylindrical cell.

26. A method comprising:
manufacturing a cap by:
providing an electrode terminal comprising a pair of first cup arms;
providing a cap plate comprising an upper surface, a lower surface and a terminal hole;
over-molding an insulator onto the electrode terminal, with an undercut of the insulator being configured to receive the pair of first cup arms;
inserting the over-molded insulator with the electrode terminal into the terminal hole; and
melting the insulator to bond the cap plate onto the terminal by application heat;
wherein the insulator is designed to have a unibody structure.

27. The method of claim 26, further comprising:
pre-treating surfaces of the electrode terminal and cap plate that are in contact with the insulator with Cr4+.
